(19) United States
(12) Patent Application Publication
(10) Pub. No.: US 2005/0227744 A1
(43) Pub. Date: Oct. 13, 2005

(54) System and method for a simplified cable tuner

(76) Inventors: Yen-Fu Chiang, Taipei (TW); Hai-Shen Liu, Jhong-he City (TW); Chih-Ta Lu, Taipei (TW)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/820,594

(22) Filed: Apr. 8, 2004

(51) Int. Cl. H04N 7/16

(52) U.S. Cl. 455/575.1; 455/575.8

(57) ABSTRACT

A radio frequency (RF) tuner includes a tuner housing, a cover coupled to a first side of the housing, and a tuner printed circuit board (PCB) including a plurality of layers coupled to a second side of the housing, wherein the layers are configured to shield the tuner PCB thereby reducing electromagnetic interference emissions and RF radiated fields in said PCB.

### FIELD

The present system and method relate to cable tuners. More particularly, the present system and method provide a system and method for using a printed circuit board as an integral finger connector and a shield bottom cover of a cable tuner.

### BACKGROUND

The television (TV) has become ubiquitous in modern society. As a result, a variety of services are being provided via TV. Many of these services are provided using a set-top box that works in conjunction with the TV to provide the desired service. A set-top box is for use with standard television sets to enable those television sets to receive video and/or audio signals transmitted over cable or satellite networks. Set-top boxes receive many channels of video and audio data which are coded and multiplexed. The set top box therefore includes a number of processing units for performing various functions.

FIG. 1 illustrates the components of a set-top box (100) as known in the art. As shown in FIG. 1, a set-top box (100) may include a tuner (110), a demodulator (120), a media access control (130), a modulator (140), and a central processing unit (150). The tuner (110), also known as a variable frequency oscillator, is an electronic device that can receive data signals by adjusting the resonant frequency of its circuitry to match the frequency of the data signal carrier. Consequently, the tuner (110) serves as the interface between the set-top box (100) and a cable network or other media source. Often, for space efficiency within the set-top box (100), the tuner (110) was mounted vertically to the other components of the set top box. After the tuner (110) receives a signal, it is passed to the demodulator (120) and other components of the set-top box (100) for processing.

One traditional concern with the manufacture of tuner assemblies is a desire to reduce and eliminate spurious signals and interference created by electromagnetic interference (EMI) emission. In order to reduce the effects of EMI emission and comply with the standards for EMI emissions in FCC part 15.109(a), traditional tuners (110) were manufactured with a number of shielded covers which added to the cost of producing as well as the size of the traditional tuners (110). Due to the bulkiness of the shields, these tuners were often referred to as can tuners. The shielded covers were used not only to reduce EMI emissions. The shield covers also helped control RF radiated fields and aided in the rejection of beats of the interference products outside the tuner (110) but inside the set-top box (100). However, the number of components and complexity of design add to the cost of traditional can tuners. Therefore there is a need for an effective and less complex vertical mount type tuner assembly.

### SUMMARY

A radio frequency (RF) tuner includes a tuner housing, a cover coupled to a first side of the housing, and a tuner printed circuit board (PCB) including a plurality of layers coupled to a second side of the housing, wherein the layers are configured to shield the tuner PCB thereby reducing electromagnetic interference emissions and RF radiated fields in said PCB.

According to a second embodiment, an RF tuner includes a tuner PCB, the tuner PCB including a plurality of finger connector extrusions formed in the tuner PCB, the connector extrusions being configured to electrically couple the tuner PCB to a separate PCB.

### BRIEF DESCRIPTION OF THE DRAWINGS

The accompanying drawings illustrate various embodiments of the present system and method and are a part of the specification. Together with the following description, the drawings demonstrate and explain the principles of the present system and method. The illustrated embodiments are merely examples of the present system and method and in no way limit the scope there of.

FIG. 1 is a simple block diagram illustrating the components of a set-top box according to one exemplary embodiment.

FIG. 2 is an exploded view illustrating the components of a traditional can tuner.

FIG. 3 is an exploded view illustrating the components of a vertical mount tuner module according to one exemplary embodiment.

FIG. 4 is a planer view of a bottom layer of a tuner PCB illustrating the PCB extended finger tabs according to one exemplary embodiment.

FIG. 5 is a planar view of a top layer of a tuner PCB according to one exemplary embodiment.

FIG. 6 is a partial view of a second layer of a tuner PCB according to one exemplary embodiment.

FIG. 7 is a partial view of a third layer of a tuner PCB according to one exemplary embodiment.

FIG. 8 is a partial view of a fourth layer of a tuner PCB according to one exemplary embodiment.

FIG. 9 is a flow chart illustrating a method for assembling a traditional can tuner.

FIG. 10 is a flow chart illustrating a vertical mount tuner assembly method according to one exemplary embodiment.

FIG. 11 is a bottom view illustrating an assembled vertical mount tuner assembly according to one exemplary embodiment.

FIG. 12 is an assembled view illustrating a vertical mount tuner module coupled to a printed circuit board (PCB) of a set-top box according to one exemplary embodiment.

FIG. 13 is a cross-sectional side view of a tuner PCB mounted to both a main PCB of a set-top box and a set-top box chassis according to one exemplary embodiment.

FIG. 14 is a cross-sectional perspective view illustrating a tuner PCB mounted to both a main PCB of a set-top box and a set-top box chassis according to one exemplary embodiment.

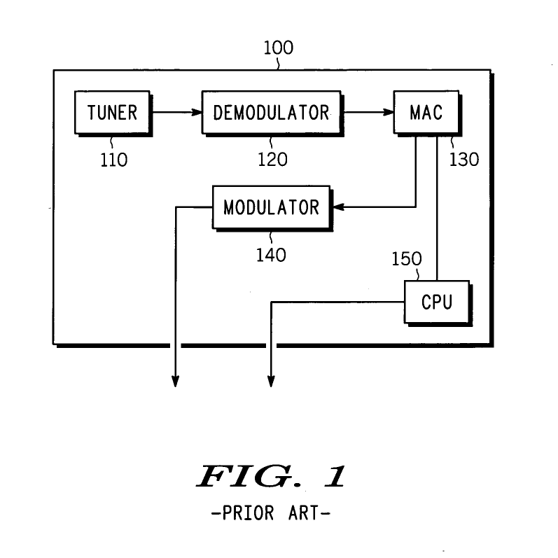

Throughout the drawings, identical reference numbers designate similar, but not necessarily identical, elements.

### DETAILED DESCRIPTION

The present specification describes a number of exemplary methods and systems for forming a vertical mount cable tuner. More specifically, the present system and method provide a vertical mount cable tuner including a printed circuit board (PCB) used as both an integral finger connector and a shielded bottom cover. The individual components and methods of assembly for the above-mentioned vertical mount cable tuner are described in detail below.

In the present specification and in the appended claims, the phrase “printed circuit board” or “PCB” is meant to be understood broadly as any component made up of layers of copper and fiberglass whose surface features a pattern of copper lines, or “traces,” that provide electrical connections for chips and other components.

A “set-top box” or “STB” is meant to be understood broadly as any electrical component that is configured to be located at a consumer location, receive a signal from a signal transmission source such as a satellite head-end unit or a cable head-end unit, and process data associated with the received signal. One example of a set-top box is an “integrated receiver decoder”or “IRD.”

In the following description, for purposes of explanation, numerous specific details are set forth in order to provide a thorough understanding of the present system and method for forming a vertical mount cable tuner. It will be apparent, however, to one skilled in the art that the present method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

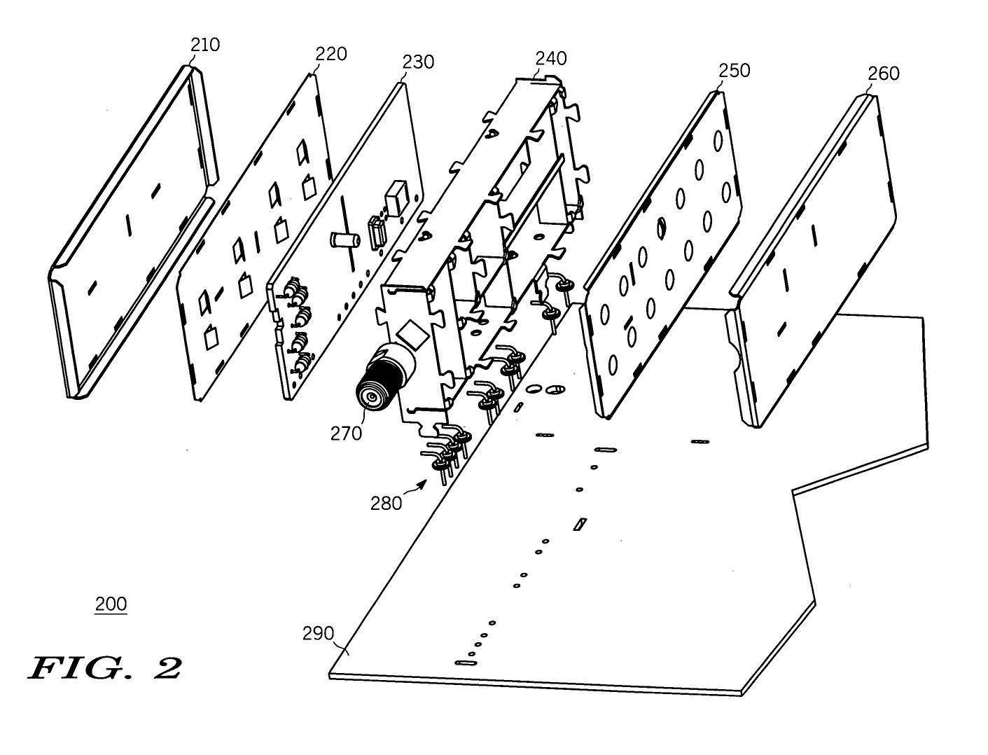

As illustrated in FIG. 2, traditional “can tuners” (200) included a number of different components in order to meet EMI emission limit requirement per FCC part 15.109(a) as well as to keep radio frequency (RF) radiated fields at an acceptable level and to meet a minimum rejection of the beats of interference products from outside the tuner but inside the set-top box that generate spurs from crystal oscillators, mixers, and other similar devices. As shown in FIG. 2, the traditional vertical mount “can tuners” (200) included a bottom cover (210) and a bottom inner shield (220) as well as a top inner shield (250) and a top cover (260) to meet the above-mentioned emission, field, and interference requirements. A tuner PCB (230) and a tuner housing (240) are coupled between the shields (220, 250) and covers (210, 260).

Traditional tuner PCBs (230) are made up of a single layer containing multiple components and traces leading to a set-top box. A number of connectors are also coupled to the traditional can tuner (200). As illustrated in FIG. 2, an “F” connector (270) is coupled to the tuner housing (240) and the tuner PCB (230) in order to allow the reception of a data signal from a cable or other data transmission network. Additionally, a number of feed through capacitors (280) or other connector schemes such as single row headers are communicatively coupled to the tuner housing (240) and the tuner PCB (230) in order to allow a vertical communicative coupling of the tuner PCB (230) to a main PCB of a set-top box (290). As illustrated in FIG. 2, the traditional can tuner (200) includes a number of components that must be both manufactured and assembled, thereby adding to the cost and time spent in the production of traditional can tuners.

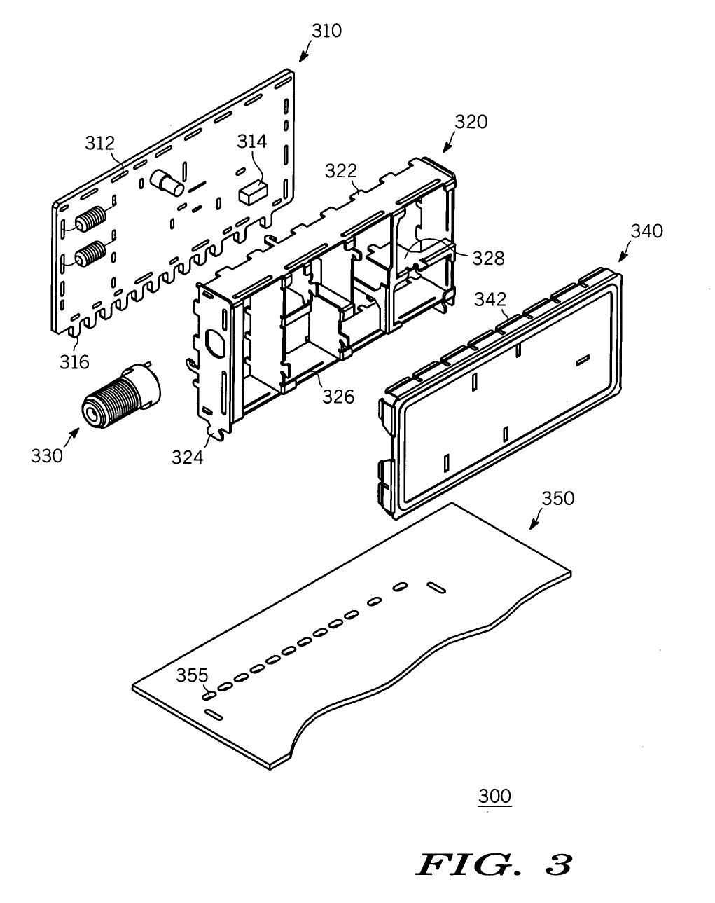

FIG. 3 illustrates a vertical mount tuner module (300) configured to reduce complexity and cost of production when compared to the traditional can tuner (200; FIG. 2) while maintaining an acceptable level of EMI emission, RF radiated fields, and rejection of beats of interference products located outside the tuner but inside the set-top box. As illustrated in FIG. 3, one exemplary embodiment of the present vertical mount tuner module (300) includes a tuner housing (320) coupled on a first side by a top cover (340) and on a second side by a tuner PCB (310). Additionally, an “F” connector is coupled to both the tuner housing (320) and the tuner PCB (310) which are subsequently configured to be coupled to the main PCB of a set-top box (350). The above-mentioned components will now be described in further detail below with reference to FIGS. 3 through 8.

As illustrated in FIG. 3, the present vertical mount tuner module (300) is built around a central tuner housing (320). The tuner housing (320) is configured much like a traditional tuner housing including a number of structural elements (328) configured to support the tuner PCB (310), while avoiding any tuner components (314) that may be extruding from the tuner PCB.

In addition to the traditional structural elements (328), the present exemplary tuner housing (320) also includes a plurality of top cover receiving ribs (326), tuner PCB coupling tabs (322), and tuner housing tabs (324). The tuner housing tabs (324) are extrusions from the tuner housing (320) configured to securely couple the tuner housing to the main PCB of the set-top box (350) in a vertical fashion. Similarly, the tuner PCB coupling tabs (322) are configured to extrude through corresponding housing slots (312) in the tuner PCB (310). Once the tuner PCB coupling tabs (322) are inserted into the corresponding housing slots (312), a reflow process may be performed to securely couple the PCB tuner (310) to the tuner housing (320). In contrast to the above mentioned extrusions, the top cover receiving ribs (326) are extrusions configured to removably receive a number of top cover securing clip tabs (342) that form a part of the top cover (340). According to this exemplary embodiment, the top cover (340) may be removably coupled to the tuner housing (320).

The top cover (340) of the present tuner module (300) includes a plurality of top cover securing clip tabs (342) as illustrated in FIG. 3. As mentioned above, the top cover securing clip tabs (342) are configured to be removably coupled to the top cover receiving ribs (326) formed in the tuner housing (320). The top cover (340) protects the tuner module (300) from contamination and provides structural support for the module. The top cover (340) illustrated in FIG. 3 may be made out of traditional materials including, but in no way limited to, metals such as aluminum or polymers.

The tuner PCB (310) illustrated in FIG. 3 includes a number of housing slots (312), as mentioned above, to receive the tuner PCB coupling tabs (322) formed on the tuner housing (320). In addition to the housing slots (312) formed in the tuner PCB (310), a number of tuner components (314) are coupled to the tuner PCB and a plurality of PCB extended finger tabs (316) are formed in the tuner PCB.

The tuner components (314) illustrated in FIG. 3 are configured to enable the tuner PCB (310) to adjusting the resonant frequency of its circuitry to match the frequency of a data signal carrier (or intermediate frequency (IF)), thereby “tuning” to a desired signal. According to one exemplary embodiment, the tuner components (314) disposed on the tuner PCB (310) include, but are in no way limited to, an up-converter variable crystal oscillator (VCO) which converts an inputted signal frequency into an intermediate frequency (IF) higher than the inputted signal frequency, and a down-converter VCO which converts an inputted signal frequency into an IF lower than the inputted signal frequency. VCOs are oscillators that produce variable electrical oscillations at a frequency determined by the physical characteristics of a piezoelectric quartz crystal.

The present exemplary tuner PCB (310) illustrated in FIG. 3 also includes a plurality of PCB extended finger tabs (316) configured to be received by a number of tab reception slots (355) formed in the main PCB of the set-top box (350). The PCB extended finger tabs (316) illustrated in FIG. 3 allow the tuner PCB (310) to be communicatively coupled to the main PCB of the set-top box (355), thereby eliminating the need for the feed through capacitors (280; FIG. 2) or other components used by traditional vertical mount can tuners (200; FIG. 2).

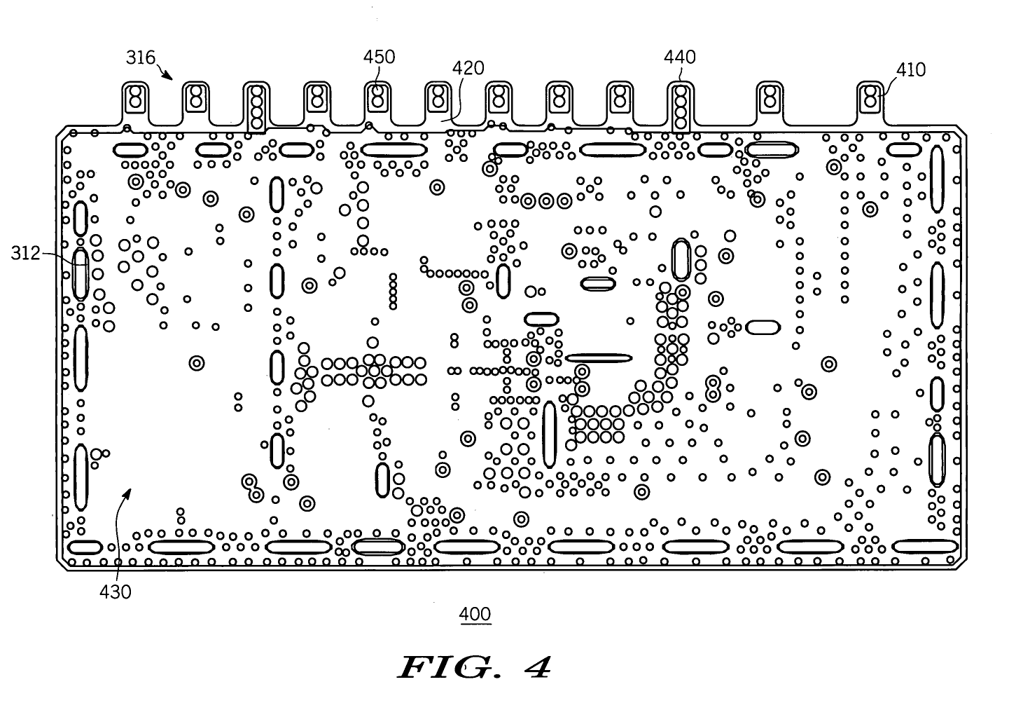

As illustrated in FIG. 4, the PCB extended finger tabs (316) are formed to extrude from the body of the tuner PCB (400). As shown in the exemplary embodiment illustrated in FIG. 4, each PCB extended finger tab (316) includes a finger connection circuitry (410) made of a conductive material such as copper foil. The finger connection circuitry (410), the location of the plated-through-holes (450), and the ground-foil (440) illustrated on the PCB extended finger tabs (316) of FIG. 4 facilitate the soldering and de-soldering from main board for initial production and post production repair. Moreover, the PCB extended finger tabs (316) are formed in a manner as to minimize the occurrence of traces peeling off of the top and the bottom of the tuner PCB (400). The finger connection circuitry (410) allows a desired trace to be formed such that it is communicatively coupled to a corresponding finger connection circuitry. As illustrated in FIG. 4, each finger connection circuitry (410) disposed on the PCB extended finger tabs (316) is originally isolated from the ground plane (430) of the tuner PCB (400) by an isolation gap (420). This isolation gap (420) allows for the selective coupling of each finger connection circuitry (410) to a corresponding trace disposed in a selected layer.

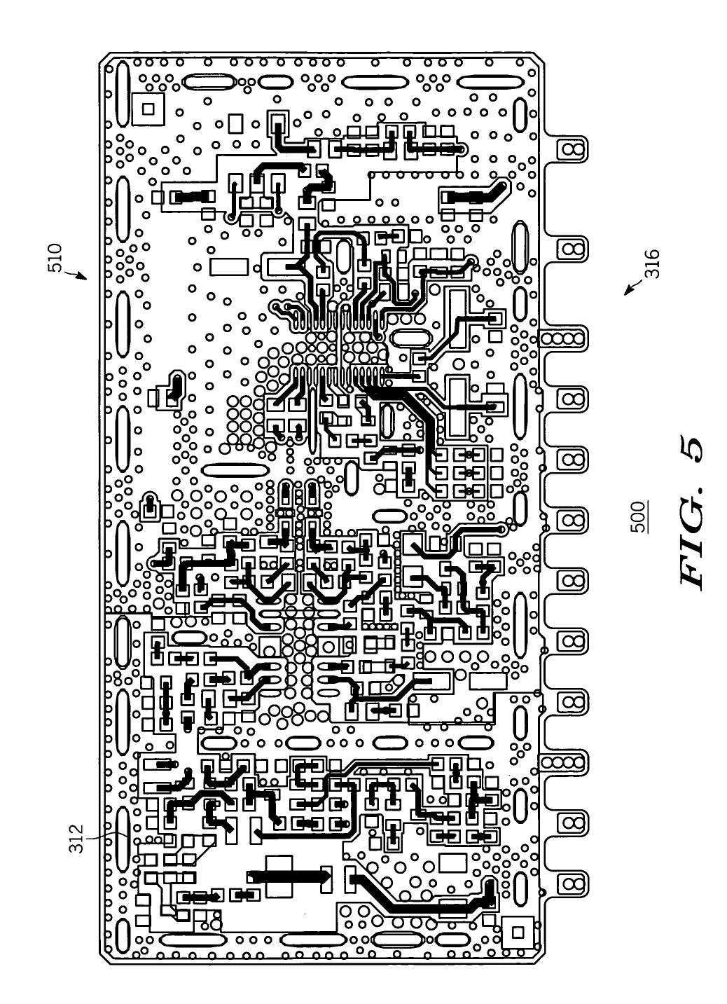

In contrast to traditional tuner PCBs, the present tuner PCB (400) includes a plurality of PCB layers coupled together. According to one exemplary embodiment, the tuner PCB (400) includes a first PCB layer serving as a component plane by housing all of the individual tuner components (314; FIG. 3), a second PCB layer serves as a major ground plane including some signal paths, a third PCB layer also serves as a major ground plane containing other signal paths, and a fourth layer serves as a total ground plane. Exemplary PCB layers will now be described with reference to FIGS. 5 through 8.

FIG. 5 illustrates a first PCB layer forming the tuner PCB (400; FIG. 4) according to one exemplary embodiment. As illustrated in the exemplary embodiment of FIG. 5, the first PCB layer is a top artwork layer (500) or component plane. As shown in FIG. 5, the top artwork layer (500) contains the tuner components (510) including, but not limited to, an up-converter VCO and a down converter VCO. Additionally, the afore-mentioned housing slots (312) are formed in the first and subsequent PCB layers forming the tuner PCB (400; FIG. 4). According to the exemplary embodiment illustrated in FIG. 5, none of the finger connection circuitry (410) is coupled to a component trace. However, the finger connection circuitry (410) is communicatively coupled to corresponding finger connection circuitry (410) in subsequent layers according to one exemplary embodiment.

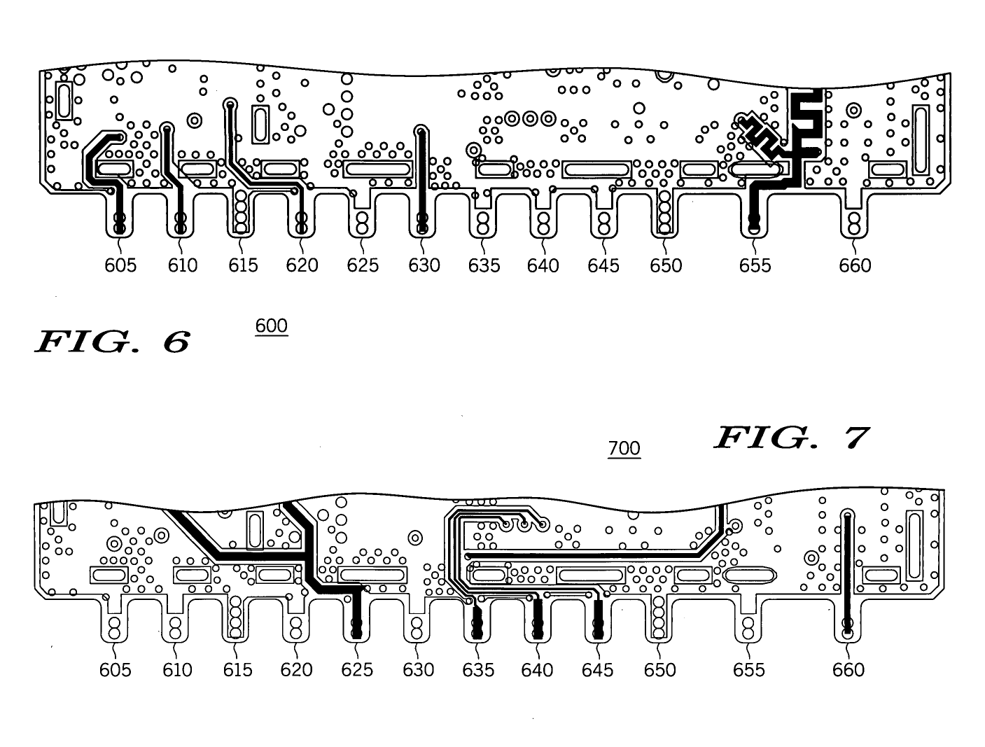

FIG. 6 illustrates the second PCB layer (600) serving as a major ground plane. As illustrated in FIG. 6, the second PCB layer of the tuner PCB (400; FIG. 4) includes a number of opening and signal paths configured to minimize the signal loss and to minimize the stray capacitance under the above tuner components (510) area. As illustrated in FIG. 6, each PCB extended finger tab (316; FIG. 3) corresponds with a defined circuitry. According to the exemplary embodiment illustrated in FIG. 6, the first extended finger tab (605) corresponds to an up-stream input circuitry, the second extended finger tab (610) corresponds to an out of band (OOB) signal output circuitry, the third extended finger tab (615) corresponds to ground, the fourth extended finger tab (620) corresponds to an automatic gain control (AGC) circuitry that may be varied from 1 to 5 volts, the fifth extended finger tab (625) corresponds with a voltage at a common collector (Vcc) circuitry of positive 5 volts, the sixth extended finger tab (630) corresponds with a Vcc circuitry of a positive 27 volts, the seventh extended finger tab (635) corresponds with a clock control line circuitry, the eighth extended finger tab (640) corresponds with a data control line circuitry, the ninth extended finger tab (645) corresponds with an enable control line circuitry, the tenth extended finger tab (650) corresponds with ground, the eleventh extended finger tab (655) corresponds with a Vcc circuitry of positive 5 volts, and the twelfth extended finger tab (660) corresponds with an intermediate frequency (IF) output circuitry. While an exemplary defined circuitry is illustrated above with reference to specific extended finger tabs, any number of circuitry and extended finger tab correspondence configurations may be used, depending on the desired use, according to the present system and method.

As illustrated in the exemplary embodiment of FIG. 6, a number of extended finger tabs (316; FIG. 3) in the second PCB layer (600) illustrated in FIG. 6 include traces running to the extended finger tabs. According to the exemplary embodiment illustrated in FIG. 6, the first (605), the second (610), the fourth (620), the sixth (630), and the eleventh (655) extended finger tabs are electrically coupled to defined circuitry through the illustrated traces. As shown, the first (605) and second (610) extended finger tabs are communicatively coupled to signal path circuitry such as the up-stream input and the OOB signal output. Additionally, a number of direct current (DC) voltage circuitries are electrically coupled to their corresponding extended finger tabs. As illustrated in FIG. 6, the fourth (620), the sixth (630), and the eleventh (655) extended finger tabs are coupled to AGC, 27 volt Vcc, and 5 volt Vcc circuitry respectively.

FIG. 7 illustrates the third PCB layer (700) serving as a major ground plane. As illustrated in FIG. 7, the third PCB layer (700) of the tuner PCB (400; FIG. 4) includes the twelve PCB extended finger tabs (316; FIG. 3) illustrated above. Additionally, as shown in FIG. 7, a number of the extended finger tabs are electrically coupled to control line circuitry, signal path circuitry, and DC voltage line circuitry through a number of traces. More specifically, extended finger tabs not coupled to defined circuitry in the second PCB layer (600) are coupled to their corresponding circuitry in the third layer (700). As illustrated in the exemplary embodiment of FIG. 7, the fifth extended finger tab (625) corresponding to the 5 volt Vcc voltage circuitry is coupled to the corresponding circuitry in the third PCB layer (700). Additionally, the seventh (635), the eighth (640), and the ninth (645) extended finger tabs corresponding to the clock control line circuitry, the data control line circuitry, and the enable control line circuitry respectively are communicatively coupled to their respective circuitry in the third PCB layer (700). Moreover, the twelfth extended finger tab (660) corresponding to the IF output circuitry is communicatively coupled in the third PCB layer (700). While a number of extended finger tabs are coupled to their corresponding circuitry in the second and third PCB layers, the lines laid in the third PCB layer (700) are designed and laid away from those lines of the second PCB layer (600) so as to minimize the mutual coupling among them. Additionally, according to the exemplary embodiment illustrated in FIG. 7, the third (615) and tenth (650) extended finger tabs are ground tabs coupled to the ground plane (430; FIG. 3) of the tuner PCB.

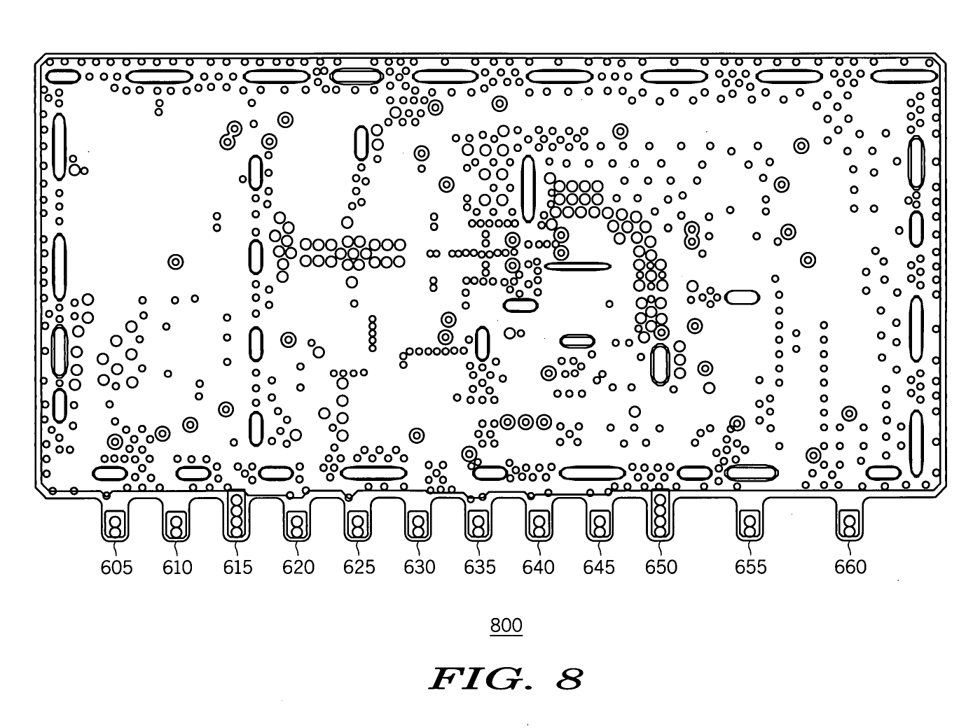

FIG. 8 illustrates the fourth PCB layer (800) of the tuner PCB that is serving as a total ground plane with no signal paths, control lines, or DC voltage paths laid therein. While no signal paths, control lines, or DC voltage paths are formed in the fourth PCB layer (800), there are a number of plated through holes (PTHs) formed in each of the PCB layers allowing for circuitry connections between the layers. However, the PTHs in each PCB layer are surrounded by the ground-foil (440; FIG. 4). By including the fourth PCB layer (800), the present tuner PCB (400; FIG. 4) may operate similar to traditionally shielded tuners. Essentially, the fourth PCB layer (800) consisting of a solid ground plane is substituted for, and functions similar to, the traditional bottom cover and inner shield used by a traditional vertical mount can tuner, thereby reducing EMI emissions, RF radiated fields, and aiding to meet a minimum rejection of the beats of interference products. Similarly, the first PCB layer (500), the second PCB layer (600), and the third PCB layer (700) surround existing traces with a ground plane to further reduce EMI emissions and RF radiated fields while aiding in the rejection of the beats of interference products. Consequently, the tuner PCB is used as both an integral finger connector and a shielded bottom cover for the vertical mount cable tuner in order to achieve a qualified performance level. While the present exemplary embodiment is illustrated in the context of a four layered PCB, the present system and method may be applied to any PCB having a plurality of layers to reduce EMI emissions and RF fields. Moreover, the present system and method may be incorporated into any conventional tuners other than cable TV tuners that include VCO circuitry including, but in no way limited to, off air TV tuners using more than one layer of a PCB.

According to one test performed by an FCC certified site using the above-mentioned tuner module, the present tuner module (300) met the FCC limit of RF emission and demonstrated RF radiated field immunity similar to that of traditional vertical mount can tuners. Additionally, the present tuner module (300) can have the beats within the output of the tuner meet the system acceptable level comparable to that of traditional tuners. Namely, all channels tested contained beats readings of 64 dBc<1 MHz/60 dBc>1 MHz referred to the corresponding test channel video carrier frequency.

Returning again to FIG. 3, each of the PCB extended finger tabs (316) are configured to be inserted into a corresponding tab reception slot (355) formed in the main PCB of the set-top box (350). Once inserted into a corresponding tab reception slot (355) the PCB extended finger tabs may be communicatively coupled to corresponding traces of the main PCB of the set-top box (350), thereby enabling two way communication between the main PCB of the set-top box and the tuner components (314).

Also illustrated in FIG. 3 is an “F” connector (330) configured to be communicatively coupled to the tuner PCB (310) through the tuner housing (320). An “F” connector is a common coaxial connector used for video applications. While an “F” connector (330) is illustrated in FIG. 3, any connector used to receive data signals from a network may be used including, but in no way limited to, an s-video connector, a fiber-optic cable connector, or an RCA connector.

Exemplary Implementation and Operation

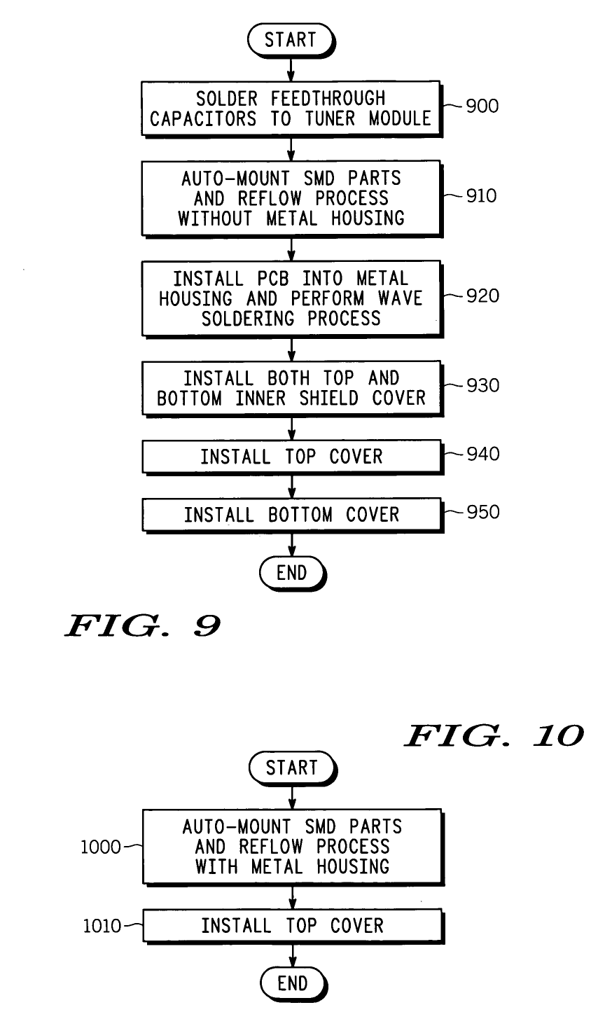

As illustrated above with reference to FIG. 2, traditional vertical mount “can tuners” (200) included a number of components thereby adding cost and complexity to the overall manufacture of the tuners. FIG. 9 illustrates an exemplary method for assembling a traditional vertical mount “can tuner” (200; FIG. 2) according to one exemplary embodiment. As illustrated in FIG. 9, the traditional assembly method included soldering the necessary feed through capacitors to the tuner module (step 900), auto-mounting the surface mount device (SMD) parts such as tuner components (314; FIG. 3) and performing a reflow process to securely couple the SMD parts to the tuner PCB (step 910). Once the tuner PCB was formed, it was mounted into the metal housing and a wave soldering process was performed to secure the tuner PCB to the metal housing (step 920). With the metal housing and the tuner PCB securely coupled, both the top and the bottom inner shield covers would be installed over the tuner PCB and metal housing (step 930) followed by the installation of the top (step 940) and the bottom (step 950) covers. As can be seen in FIG. 9, traditional vertical mount “can tuners” required a number of assembly steps in order to be ready for coupling to a main PCB of a set-top box.

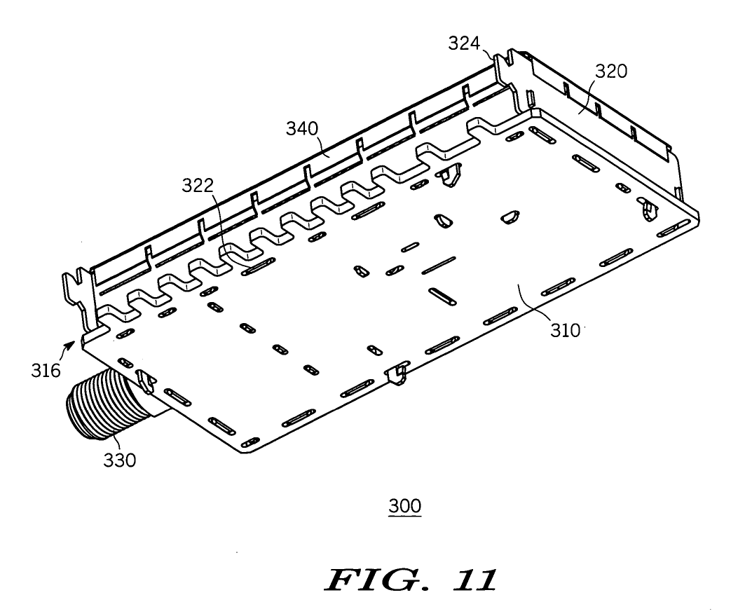

In contrast to the relatively large number of steps performed in the assembly of traditional vertical mount “can tuners” illustrated in FIG. 9, FIG. 10 illustrates the assembly method of the present system and method for forming a vertical mount cable tuner. As illustrated in FIG. 10, the present vertical mount cable tuner may be assembled by a few simple steps, thereby reducing the cost of production when compared to traditional vertical mount “can tuners.” As illustrated in FIG. 10, assembly of the present vertical mount cable tuner begins, according to one exemplary embodiment, by auto-mounting the SMD parts, such as the tuner components (314; FIG. 3) onto the tuner PCB and performing a reflow process (step 1000) coupling both the SMD parts and the metal housing to the tuner PCB. Once coupled through the reflow process, the top cover may be installed (step 1010) thereby completing the assembly. Further detail of the above-mentioned method will be given below with reference to FIGS. 11 through 14.

As illustrated in FIG. 10, the present assembly method begins by auto-mounting SMD parts and the metal housing to the tuner PCB followed by a reflow process (step 1000). FIG. 11 illustrates an assembled tuner module (300) according to one exemplary embodiment. As shown in FIG. 11, when the SMD parts are coupled to the tuner PCB (310), leads to the tuner components are passed through the PTHs of the multiple layers forming the tuner PCB so that they may be coupled to the tuner PCB (310) by a single reflow process. Similarly, when the tuner housing (320) is coupled to the tuner PCB (310), the tuner PCB coupling tabs (322) pass through the housing slots (312; FIG. 3) formed in each layer of the tuner PCB (310) and are exposed on the back of the tuner PCB enabling the tuner housing to be coupled to the tuner PCB (310) with the same reflow process used to couple the SMD parts to the tuner PCB. As illustrated in FIG. 11, when the PCB coupling tabs (322) are passed through the housing slots (312; FIG. 3), the-PCB extended finger tabs (316) are extended beyond one side of the tuner housing (320) to facilitate coupling of the tuner PCB to the main PCB of the set-top box.

Returning again to FIG. 10, the second and final step in the assembly of the present vertical mount tuner assembly is to install the top cover (step 1010). As illustrated in FIG. 11, the top cover (340) of the assembled tuner module (300) may be easily installed onto the tuner housing (320) by clipping the top cover securing clip tabs (342; FIG. 3) to the top cover receiving ribs (326) thereby forming an interference fit.

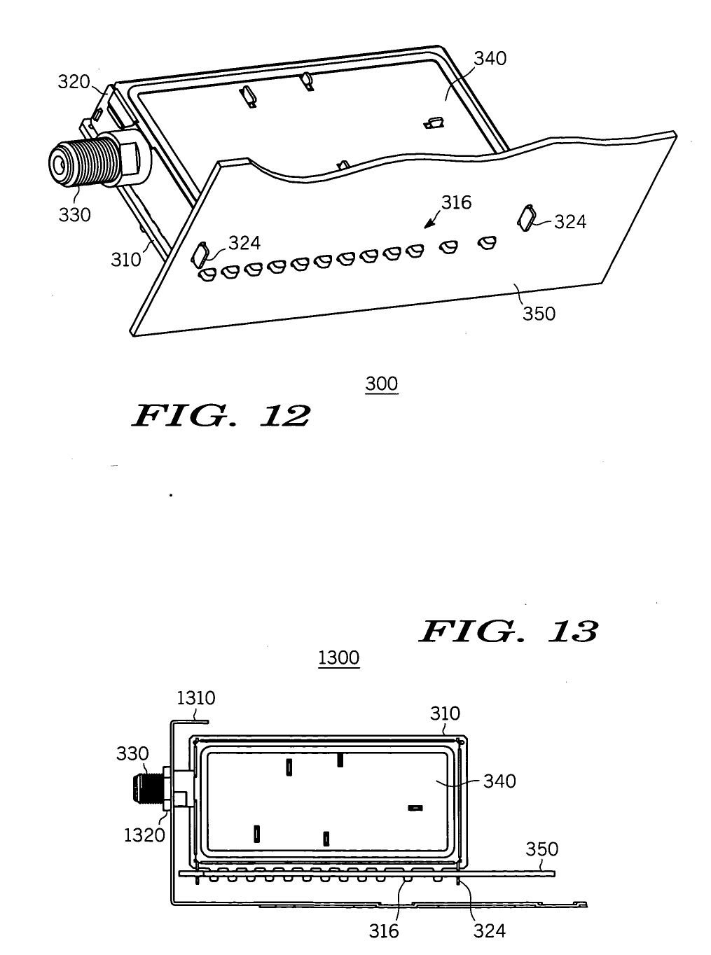

Once the tuner module (300) is assembled as illustrated in FIG. 11, the tuner module may be communicatively coupled to the main PCB of the set-top box (350) as illustrated in FIG. 12. As illustrated in FIG. 12, the tuner module (300) is communicatively coupled to the main PCB of the set-top box (350) by passing both the PCB extended finger tabs (316) and the tuner housing tabs (324) through the tab reception slots (355; FIG. 3) formed in the main PCB of the set-top box. Once the tabs have been passed through the tab reception slots (355; FIG. 3) a reflow process may be performed to communicatively and securely couple each individually spaced PCB extended finger tab (316) of the tuner module (300) to a corresponding tab reception slot (355; FIG. 3) in the main PCB of the set-top box (350) without mechanical contact concerns.

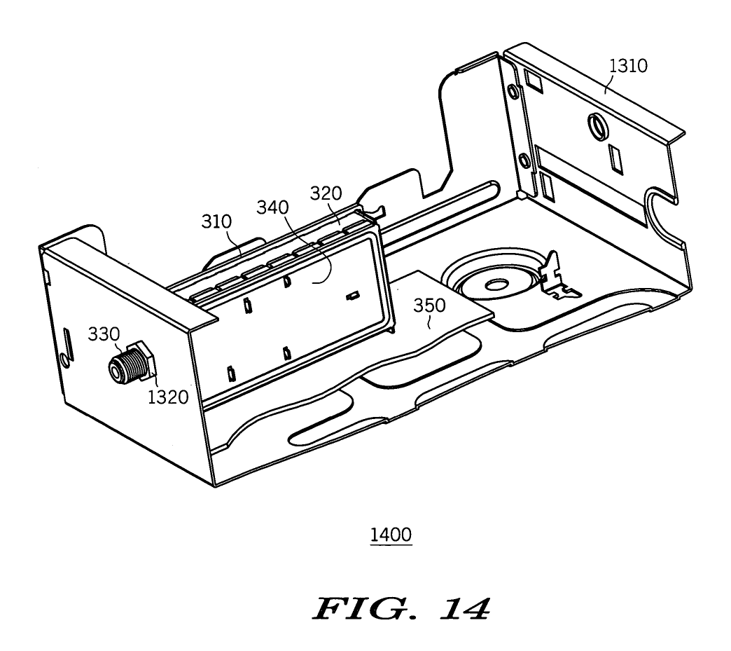

Once the tuner module (300) is coupled to the main PCB of the set-top box (350), the assembly may then be mounted to the set-top box chassis (1310) as illustrated in FIGS. 13 and 14. As shown in FIG. 13, the assembly may be mounted to the set-top box chassis (1310) by securing a mechanical fastener (1320) over the “F” connector (330) of the tuner module. To secure the tuner module (300) to the chassis of the set-top box (1310), the “F” connector (330) may be passed through an orifice formed in the chassis of the set-top box (1310). Once the “F” connector (330) is passed through the chassis of the set-top box (1310), a mechanical fastener (1320) is secured over the “F” connector against the chassis of the set-top box thereby forming an interference fit sufficient to secure the tuner module (300) to the chassis of the set-top box (1310). According to one exemplary embodiment, the mechanical fastener (1320) used to secure the tuner module (300) to the chassis of the set-top box (1310) includes, but is in no way limited to, a nut, a snap, a grommet, a rivet, or an adhesive.

In conclusion, the present system and method for forming a vertical mount cable tuner reduces the tuner complexity and assembly cost while maintaining an acceptable level of EMI emission, RF radiated fields, and rejection of beats of interference products located outside the tuner but inside the set-top box. More specifically, by using multiple layers to form the tuner PCB, the component circuitry paths may be designed to be shielded by adjacent PCB layers thereby eliminating the need for traditional shields and covers. Additionally, the present tuner set-top box includes a number of PCB extended finger tabs that facilitate the coupling of the tuner PCB to the main PCB of a set-top box, thereby eliminating the need for the traditional feed through capacitors and/or other connector schemes for I/O such as single row headers.

The preceding description has been presented only to illustrate and describe the present system and method. It is not intended to be exhaustive or to limit the present system and method to any precise form disclosed. Many modifications and variations are possible in light of the above teachings.

The foregoing embodiments were chosen and described in order to illustrate principles of the system and method as well as some practical applications. The preceding description enables others skilled in the art to utilize the system and method in various embodiments and with various modifications as are suited to the particular use contemplated. It is intended that the scope of the system and method be defined by the following claims.

1. A radio frequency (RF) tuner comprising:
a tuner housing;
a cover coupled to a first side of said housing; and
a tuner printed circuit board (PCB) including a plurality of layers coupled to a second side of said housing;
wherein said layers are configured to shield said tuner PCB.

2. The RF tuner of claim 1, wherein said tuner PCB further comprises:
a plurality of finger connector extrusions formed in said tuner PCB;
said connector extrusions being configured to electrically couple said tuner PCB to a second PCB.

3. The RF tuner of claim 2, wherein said tuner further comprises a vertical mount tuner.

4. The RF tuner of claim 1, wherein said tuner housing further comprises:
a plurality of support members;
a plurality of extrusions, said extrusions being configured to extrude through a plurality of corresponding orifices in said tuner PCB; and
a plurality of ribs configured to receive a corresponding plurality of clip tabs of said cover.

5. The RF tuner of claim 1, wherein a bottom layer of said plurality of layers comprises a solid ground plane configured to form a shield.

6. The RF tuner of claim 1, further comprising a network connector communicatively coupled to said tuner PCB.

7. The RF tuner of claim 6, wherein said network connector comprises a coaxial cable connector.

8. The RF tuner of claim 1, wherein said tuner PCB further comprises:
a top layer, said top layer including a plurality of tuner components;
an intermediate layer, said intermediate layer including a major ground plane having a number of signal paths and direct current (DC) voltage lines; and
a bottom layer, said bottom layer including a total ground plane.

9. The RF tuner of claim 8, wherein said tuner PCB is coupled to said tuner housing adjoining said top layer and said housing.

10. The RF tuner of claim 8, further comprising a plurality of plated through holes disposed in said top layer, said intermediate layer, and said bottom layer.

11. The RF tuner of claim 8, wherein said tuner PCB further comprises:
a plurality of finger connector extrusions formed in said top layer, said intermediate layer, and said bottom layer;
said connector extrusions being configured to electrically couple said tuner PCB to a second PCB.

12. The RF tuner of claim 11, wherein said second PCB comprises a main PCB of a set-top box.

13. The RF tuner of claim 8, wherein said tuner components comprise:
an up-converter variable crystal oscillator (VCO); and
a down-converter VCO.

14. A set-top box comprising:
a chassis;
a tuner coupled to said chassis;
a demodulator communicatively coupled to said tuner; and
a central processing unit (CPU) communicatively coupled to said demodulator;
wherein said tuner includes a tuner housing, a cover coupled to a first side of said housing, and a tuner printed circuit board (PCB) including a plurality of layers coupled to a second side of said housing, wherein said layers are configured to shield said tuner PCB.

15. The set-top box of claim 14, wherein said tuner further comprises:
a plurality of finger connector extrusions formed in said tuner PCB;
said connector extrusions being configured to electrically couple said tuner PCB to a second PCB.

16. The set-top box of claim 15, wherein said second PCB comprises a main PCB of said set-top box.

17. The set-top box of claim 14, wherein said tuner further comprises a vertical mount tuner.

18. The set-top box of claim 14, wherein said tuner housing further comprises:
a plurality of support members;
a plurality of extrusions, said extrusions being configured to extrude through a plurality of corresponding orifices in said tuner PCB; and
a plurality of ribs configured to receive a corresponding plurality of clip tabs of said cover.

19. The set-top box of claim 14, wherein said tuner PCB further comprises:
a top layer, said top layer including a plurality of tuner components;
an intermediate layer, said intermediate layer including a major ground plane having a number of signal paths and direct current (DC) voltage lines; and
a bottom layer including a total ground plane.

20. The set-top box of claim 19, further comprising a plurality of plated through holes disposed in said top layer, said intermediate layer, and said bottom layer.

21. The set-top box of claim 19, wherein said tuner components comprise:
an up-converter variable crystal oscillator (VCO); and
a down-converter VCO.

22. A method of assembling an RF tuner comprising:
coupling a tuner printed circuit board (PCB) to a first side of a tuner housing; and
coupling a tuner cover to a second side of said tuner housing;
wherein said tuner PCB includes a plurality of layers configured to shield said tuner PCB.

23. The method of claim 22, wherein said coupling a tuner PCB to a first side of a tuner housing comprises:
inserting a plurality of extrusions of said tuner housing through a plurality of corresponding orifices in said tuner PCB; and
performing a solder reflow process on said plurality of extrusions.

24. The method of claim 23, further comprising:
inserting a plurality of RF tuner components through said tuner PCB; and
securing said plurality of RF tuner components to said tuner PCB using said reflow process.

25. The method of claim 22, further comprising:
forming a plurality of finger connector extrusions in said tuner PCB;
said connector extrusions being configured to electrically couple said tuner PCB to a second PCB.

26. The method of claim 22, wherein said coupling a tuner cover to a second side of said tuner housing further comprises:
forming a plurality of ribs in said tuner housing;
forming a plurality of clip tabs in said cover; and
inserting said plurality of clip tabs into said ribs to form an interference fit.

27. A method of forming a tuner printed circuit board (PCB) comprising:
forming a top layer of said tuner PCB including coupling a plurality of tuner components;
forming an intermediate layer of said tuner PCB, said intermediate layer including a major ground plane having a number of signal paths and direct current (DC) voltage lines formed therein; and
forming a bottom layer of said tuner PCB including a total ground plane.

28. The method of forming a tuner PCB of claim 27, further comprising:
forming a plurality of finger connector extrusions in said tuner PCB;
said connector extrusions being configured to electrically couple said tuner PCB to a separate PCB.

29. The method of forming a tuner PCB of claim 27, further comprising:
forming a plurality of plated through holes in said top layer, said intermediate layer, and said bottom layer;
said plated through holes corresponding to said plurality of tuner components.

30. The method of forming a tuner PCB of claim 29, wherein said tuner components comprise:
an up-converter variable crystal oscillator (VCO); and
a down-converter VCO.
